(19) United States
(12) Patent Application Publication
(10) Pub. No.: US 2007/0105011 A1
(43) Pub. Date: May 10, 2007

(54) Thermal battery

(75) Inventor: Syozo Fujiwara, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO.,LTD., Osaka (JP)

(21) Appl. No.: 11/593,511

(22) Filed: Nov. 7, 2006

(30) Foreign Application Priority Data
Nov. 10, 2005 (JP) 2005-325683

(51) Int. Cl. H01M 6/36

(52) U.S. Cl. 429/112; 429/199

(57) ABSTRACT

A thermal battery of the present invention includes a unit cell including a positive electrode, a negative electrode, and an electrolyte. The electrolyte includes a salt molten at an operating temperature of the thermal battery. The salt includes an inorganic cation and an inorganic anion, and the inorganic anion includes at least an iodine anion.

### FIELD OF THE INVENTION

The present invention relates to thermal batteries, especially to an electrolyte material used for thermal batteries.

### BACKGROUND OF THE INVENTION

Generally, thermal batteries include a plurality of unit cells. Each unit cell comprises a negative electrode, a positive electrode, and an electrolyte interposed between the negative electrode and the positive electrode. For the electrolyte, generally, a salt that is molten at high temperatures is employed. At ambient temperature, this electrolyte is not ion-conductive, and therefore the thermal battery is in inactive state. When heat is applied to the electrolyte to give high temperatures, the electrolyte will be in molten state and becomes an excellent ion-conductor, thereby bringing the thermal battery into active state and enabling a supply of electricity to the outside.

Thermal batteries are a kind of reserve battery. The battery reaction is not advanced unless the electrolyte melts. Thus, even after 5 to 10 years or more of storage, the same battery performance as the performance right after its manufacture can be achieved. The electrode reaction of the thermal battery advances at high temperatures. Thus, the electrode reactions advance far more rapidly compared with other batteries using an aqueous solution electrolyte, an organic electrolyte, and the like. Therefore, thermal batteries have excellent large current discharge performance. Further, thermal batteries are advantageous in that when an activation signal is sent to the battery upon usage, electricity becomes available in a short period of time, i.e., within a second, though the period of time varies depending upon the heating method. Thus, based on these advantageous characteristics, thermal batteries are suitably used as a power source for various ordnance devices such as a guidance system, or as an emergency power source.

Recently, with devices using thermal batteries becoming more high performance, small-sized, and lightweight, thermal batteries are required to have a further longer operation time, smaller size, and lighter weight.

After the salt in the electrolyte is melted and a thermal battery is operated, heat of the battery as a whole is released to the outside. Thus, an important factor contributing to the operation time (discharge time) of thermal batteries is, the time period from the start of the thermal battery operation, to the time when the temperature of the thermal battery is decreased and the salt in molten state is re-solidified.

Thus, for a method to increase the operation time of thermal batteries, time for the salt in molten state to re-solidify may be extended, for example by using a salt with a low melting point for the electrolyte to decrease the operation temperature of thermal batteries, and assuming the same operation temperature of thermal batteries and the same component material forming the thermal battery other than the electrolyte (that is, the same adiabatic coefficient and usage amount of the material).

In thermal batteries, generally, a heating agent for heating the unit cell to melt the electrolyte is disposed inside the battery. Also, upon designing thermal batteries, a total heat capacity is calculated by using the specific heats of components forming the thermal battery to set the amount of the heating agent to be disposed in the battery, to be able to obtain necessary amount of heat for melting the salt to be used for the electrolyte.

For example, in conventional thermal batteries using iron disulfide in its positive electrode, lithium metal or the lithium-containing alloy in its negative electrode, and LiCl—KCl for its electrolyte, the temperature range during battery operation is set according to purpose of usage, but usually, the amount of heating agent is set so that the temperature inside the battery is about 500° C. (a temperature slightly higher than the melting point of the electrolyte). Also, for example, in thermal batteries using LiBr—LiCl—LiF for the electrolyte, the amount of the heating agent is set so that the temperature inside the battery becomes about 550° C.

Therefore, by using a salt with a low melting point for the electrolyte, the amount of heat necessary for melting the salt decreases, achieving decrease in the amount of heating agent to be used, and also small-sized, lightweight thermal battery.

In the field of thermal batteries, various examinations have been conducted on electrolytes to improve battery performance. For example, in Japanese Patent No. 2643344, to improve output performance, usage of a mixture of LiF, LiCl, and LiBr for the electrolyte has been proposed. In Japanese Laid-Open Patent Publication No. Hei 05-54894, usage of a mixture of LiBr, KBr, and LiCl for the electrolyte has been proposed. Further, in Japanese Laid-Open Patent Publication No. Hei 10-172581, usage of a mixture of LiCl—KCl, KBr—LiBr—LiCl, or LiBr—KBr—LiF, LiBr—LiCl—LiF for the electrolyte has been proposed.

However, it is difficult to obtain thermal batteries satisfying the recently required performance by using the above electrolytes. Also, examinations for such an electrolyte noted in the above is still insufficient for achieving the level of thermal battery performance demanded recently.

Thus, to solve the conventional problems as noted in the above, the present invention aims to provide a small and lightweight thermal battery in which time for an electrolyte in molten state to re-solidify is extended for a longer operation time, and the amount of the heating agent used is reduced.

### BRIEF SUMMARY OF THE INVENTION

A thermal battery including a unit cell comprising: a positive electrode; a negative electrode; and an electrolyte disposed between the positive electrode and the negative electrode, the electrolyte comprising a salt molten at an operating temperature of the thermal battery, the salt comprising an inorganic cation and an inorganic anion, wherein the inorganic anion includes at least an iodine anion.

The inorganic cation is preferably at least one selected from the group consisting of lithium cation, sodium cation, potassium cation, rubidium cation, and cesium cation.

The inorganic anion is preferably at least one selected from the group consisting of the iodine anion, fluorine anion, chlorine anion, bromine anion, nitric acid anion, and carbonic acid anion.

The salt preferably comprises at least a first salt including the iodine anion, and a second salt including at least one inorganic anion selected from the group consisting of the iodine anion, fluorine anion, chlorine anion, bromine anion, nitric acid anion, and carbonic acid anion.

The first salt is preferably at least one selected from the group consisting of LiI, NaI, KI, RbI, and CsI.

At least one of the negative electrode and the positive electrode preferably includes a salt including an iodine anion.

The present-invention achieves a longer operation time, since the use of iodide extends the time for the electrolyte in molten state to re-solidify. Also, since the amount of the heating agent to be used can be reduced, small-sized, lightweight thermal batteries can be achieved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a perspective view showing partially cutaway cross sections of a thermal battery of an embodiment of the present invention.

FIG. 2 is an exploded cross sectional view of a unit cell used in the thermal battery in FIG. 1.

### DETAILED DESCRIPTION OF THE INVENTION

A thermal battery of the present invention includes a unit cell comprising a positive electrode, a negative electrode, and an electrolyte including a salt molten at an operating temperature of thermal batteries (molten salt)(in other words, the electrolyte is inert at room temperature and becomes active by being melted at a predetermined temperature). The electrolyte is disposed between the positive electrode and the negative electrode, and the salt comprises an inorganic cation and an inorganic anion. The inorganic anion includes at least an iodine anion. That is, the salt used for in the electrolyte includes at least an iodide. The operating temperature of the thermal battery is higher than the melting point of the salt used for electrolyte.

Based on such thermal batteries, battery operation time can be extended, since the time for electrolyte in molten state to re-solidify after the drop in battery's operating temperature is extended, with the specific battery structure and harsh ambient temperature, and under severe discharge conditions of thermal batteries. Also, the decrease in the amount of heating agent to be used enables small and lightweight batteries.

The above effects are probably due to a low melting point of iodide, compared with a melting point of other halide conventionally used for electrolytes. The low melting point is probably because iodines are for example low in electronegativity (criterion for ability to attract electrons) compared with fluorine, chlorine, and bromine, and stability of compounds including iodine declines more than the other halogen compounds.

At the same time, since iodides have excellent ion conductivity in molten state, thermal batteries with excellent high-rate discharge performance can be obtained.

The iodide is, for example, a compound of I and at least one alkaline metal element selected from the group consisting of Li, Na, K, Rb, and Cs. Also, the iodide is, for example, a compound of I and at least one alkaline earth metal element selected from the group consisting of Be, Mg, Ca, Sr, and Ba.

Among the above iodides, the iodide is preferably LiI, NaI, KI, RbI, and CsI, because of the low melting point and the excellent ion conductivity in molten state.

The inorganic cation mentioned above is preferably at least one selected from the group consisting of lithium cation, sodium cation, potassium cation, rubidium cation, and cesium cation. The inorganic anion mentioned above is preferably at least one selected from the group consisting of iodine anion, fluorine anion, chlorine anion, bromine anion, nitric acid anion, and carbonic acid anion.

The electrolyte preferably includes two or more salts with different composition, in view of the low melting point. Even when the electrolyte includes a mixture of higher salts such as binary, tertiary, or tetra-salt, with the presence of iodide in the electrolyte, similar effects can be exhibited. For the mixture of salt, eutectic compositions with the maximum effect of the drop in melting point is preferable, but the composition and the mixture ratio of the salt mixture is not particularly limited, as long as iodide is included and desired performance can be exhibited.

For example, the salt included in the electrolyte preferably comprises at least a first salt including the iodine anion, and a second salt including at least one selected from the group consisting of the iodine anion, fluorine anion, chlorine anion, bromine anion, nitric acid anion, and carbonic acid anion.

For the first salt including the iodine anion, the above iodides may be mentioned. For the second salt, the above iodides different from the first salt, or the salts other than the iodides, not inluding iodine anion, may be mentioned.

For the salts other than the iodides, for example, a halogen compound comprising at least one element selected from the group consisting of Li, Na, K, Rb, and Cs, and at least one element selected from the group consisting of F, Cl, and Br may be mentioned. A nitric acid compound including at least one element selected from the group consisting of Li, Na, K, Rb, and Cs may be mentioned. A carbonic acid compound including at least one element selected from the group consisting of Li, Na, K, Rb, and Cs may be mentioned.

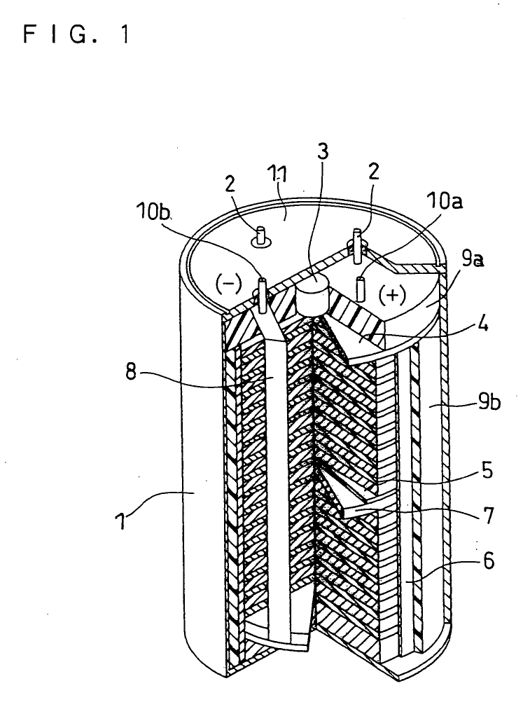

An example of a thermal battery of the present invention is described by referring to FIG. 1.

A power-generating portion, in which a plurality of unit cells 7 and heating agents 5 are alternately stacked, is stored in a metal-made outer case 1. On top of the power-generating portion, an ignition pad 4 is disposed, and in the proximity of the top of the ignition pad 4, an igniter 3 is disposed. Along the circumference of the power-generating portion, a fuse wrap 6 is disposed. The heating agent 5 includes an iron powder and is conductive. Thus, the unit cells 7 are electrically connected in series with the heating agents 5 interposed therebetween. The heating agent 5 comprises, for example, a mixture of Fe and KClO₄, and since the Fe powder is sintered at the time of the battery activation along with the combustion of the heating agent 5, the conductivity of the heating agent 5 is maintained, from the start of discharge (the start of combustion) to the termination of discharge (the termination of combustion).

The outer case 1 is sealed by a battery lid 11 having a pair of ignition terminals 2, i.e., a positive terminal 10a, and a negative terminal 10b. The positive terminal 10a is connected to the positive electrode of the uppermost unit cell 7 in the power-generating portion, via a positive electrode lead plate. On the other hand, the negative terminal 10b is connected to the negative electrode of the lowermost unit cell 7 in the power-generating portion, via a negative electrode lead plate 8. Between the battery lid 11 and the ignition pad 4, a thermal insulating material 9a is disposed, and between the outer case 1 and the power-generating portion, a thermal insulating material 9b is filled.

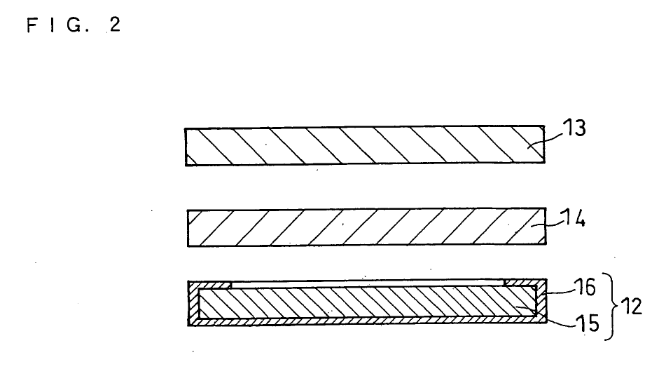

As shown in FIG. 2, the unit cell 7 comprises a negative electrode 12, a positive electrode 13, and an electrolyte 14 disposed between the negative electrode 12 and the positive electrode 13.

As shown in FIG. 2, the negative electrode 12 comprises a negative electrode material mixture layer 15 including a negative electrode active material, and an iron-made cup-like current collector 16 housing the negative electrode material mixture layer 15. The negative electrode active material is not particularly limited, as long as the one can be used for thermal batteries. For the negative electrode active material, for example, lithium alloys such as Li—Al alloy, Li—Si alloy, or Li—B may be used.

The positive electrode 13 includes a positive electrode active. The positive electrode active material is not particularly limited, as long as the one can be used for thermal batteries. For the positive electrode active material, for example, manganese oxides such as MnO₂; vanadium oxides such as V₂O₅; sulfides such as FeS₂; molybdenum oxides; or lithium-containing oxides may be used.

At least one of the positive electrode and the negative electrode preferably includes a salt including a iodine anion. The salt added to the electrode may be the same salt as the electrolyte includes, or may be different from the salt used for electrolyte, even when the melting point of the salt added to the electrode is eqal or close to the melting point of the salt used for electrolyte.

The electrolyte 14 comprises, for example, a mixture of the above salt (molten salt) that is melted at operating temperatures of thermal batteries, and a retainer. For the retainer, for example, a non-conductive inorganic material such as MgO are used. By including at least iodide in the salt to be used for the electrolyte, as in the above, the time for the electrolyte in molten state to re-solidify is extended, thus operation time of batteries can be extended. Also, with the decrease in the amount of the heating agent to be used, small-sized, lightweight batteries can be achieved.

The operation of the above thermal battery is described below.

From a power source connected to the ignition terminal 2, a high voltage is applied to the ignition terminal 2 to fire the igniter 3. The combustion is transferred to the ignition pad 4 and a fuse wrap 6, to combust the heating agent 5 to heat the unit cell 7. Then, the electrolyte 14 of the unit cell 7 is melted to become a molten salt, i.e. an ion-conductor. The battery is thus activated to enable discharge.

Although the above-described is an internally-heated thermal battery, in which an igniter is provided inside of the battery and the battery is activated by heating the power-generating portion from inside of the battery, the present invention can be applied to an externally-heated thermal battery as well, in which an igniter is not provided inside of the battery and the battery is activated by heating the power-generating portion with a heater such as a burner from outside of the battery.

Although Examples of the present invention are described in detail in the following, the present invention is not limited to these Examples.

### EXAMPLE 1

A unit cell shown in FIG. 2 was prepared as described below. The preparation of the unit cell was basically carried out in an environment of dry air with the dew point of −50° C. or below, where influences from moisture were eliminated to the maximum.

(1) Preparation of Electrolyte

Lithium fluoride (LiF) (Composition 1) and lithium iodide (LiI) (Composition 2) were dried under vacuum environment at 200° C. for 48 hours. After drying, LiF and LiI were mixed in a mole ratio of 17:83 in a glove box with an argon atmosphere and a controlled dew point. Afterwards, an appropriate amount of this mixture was transferred to a crucible of high-purity alumina, and heated and melted in a smelting furnace with an argon atmosphere and a controlled dew point, to obtain a salt mixture of LiF and LiI. After the obtained salt mixture was cooled naturally, the mixture was crushed by using a stainless-made ball mill under an argon atmosphere with a controlled dew point for about 12 hours, to make it into powder. The obtained salt mixture powder was sieved with a 60-mesh sieve (opening of 250 μm).

The obtained salt mixture powder and magnesium oxide (MgO) were mixed in a weight ratio of 60:40. The mixture of the salt mixture and MgO was heated in a smelting furnace at 500° C. for 12 hours, to sufficiently blend the salt mixture with MgO. After the heating, the obtained mixture was cooled naturally, and crushed by using a stainless-made ball mill under an argon atmosphere with a controlled dew point for about 12 hours. The obtained powder was sieved with a 60-mesh (opening of 250 μm) sieve. A pressure of 3 ton/cm² was applied to the obtained powder mixture, to obtain a disk electrolyte 14 with a diameter of 13 mm and a thickness of about 0.5 mm.

(2) Preparation of Positive Electrode

As a positive electrode active material, FeS₂ powder (average particle size: 12 μm), the above salt mixture, and silica powder (average particle size: about 0.2 μm), were mixed in a weight ratio of 70:20:10, and a pressure of 2 ton/cm² was applied to this mixture, to obtain a disk positive electrode 13 with a diameter of 13 mm and a thickness of about 0.4 mm.

(3) Preparation of Negative Electrode

As a negative electrode active material, Li—Al alloy powder (lithium content: 20 wt %) and the above salt mixture were mixed in a weight ratio of 65:35, and a pressure of 3 ton/cm² was applied to this mixture, to obtain a negative electrode material mixture layer 15 with a diameter of 11 mm and a thickness of about 0.4 mm.

Then, the negative electrode material mixture layer 15 was placed in a cup-like, stainless steel SUS304-made current collector 16. The opening end of the current collector 16 was bent inwardly to crimp the peripheral portion of the negative electrode material mixture layer 15, thereby clamping the negative electrode material mixture layer 15 between the bent portion and the bottom portion of the current collector 16. The negative electrode material mixture layer 15 was thus fixed in the current collector 16, to obtain a disk negative electrode 12 with a diameter of 13 mm and a thickness of about 0.5 mm.

(4) Preparation of Unit Cell

The above-obtained negative electrode 12 was stacked with the positive electrode 13, with the electrolyte 14 interposed therebetween, to obtain a unit cell 7 shown in FIG. 2. The amounts of the positive electrode active material and the negative electrode active material were adjusted so that the negative electrode capacity becomes larger than the positive electrode capacity.

### EXAMPLE 2

A unit cell was made in the same manner as Example 1, except that in the electrolyte preparation, LiCl was used instead of LiF, and the mole ratio of LiCl to LiI was set to 35:65.

### EXAMPLE 3

A unit cell was made in the same manner as Example 1, except that in the electrolyte preparation, LiCl was used instead of LiF, and the mole ratio of LiCl to LiI was set to 25:75.

### EXAMPLE 4

A unit cell was made in the same manner as Example 1, except that in the electrolyte preparation, LiCl was used instead of LiF, and the mole ratio of LiCl to LiI was set to 45:55.

### EXAMPLE 5

A unit cell was made in the same manner as Example 1, except that in the electrolyte preparation, LiCl and NaI were used instead of LiF and LiI, and the mole ratio of LiCl to NaI was set to 55:45.

### EXAMPLE 6

A unit cell was made in the same manner as Example 1, except that in the electrolyte preparation, LiCl and KI were used instead of LiF and LiI, and the mole ratio of LiCl to KI was set to 63:37.

### EXAMPLE 7

A unit cell was made in the same manner as Example 1, except that in the electrolyte preparation, LiCl and RbI were used instead of LiF and LiI, and the mole ratio of LiCl and RbI was set to 58:42.

### EXAMPLE 8

A unit cell was made in the same manner as Example 1, except that in the electrolyte preparation, LiCl and CsI were used instead of LiF and LiI, and the mole ratio of LiCl to CsI was set to 58:42.

### EXAMPLE 9

A unit cell was made in the same manner as Example 1, except that in the electrolyte preparation, LiBr was used instead of LiF, and the mole ratio of LiBr to LiI was set to 37:63.

### EXAMPLE 10

A unit cell was made in the same manner as Example 1, except that in the electrolyte preparation, LiBr and NaI were used instead of LiF and LiI, and the mole ratio of LiBr to NaI was set to 60:40.

### EXAMPLE 11

A unit cell was made in the same manner as Example 1, except that in the electrolyte preparation, LiBr and KI were used instead of LiF and LiI, and the mole ratio of LiBr to KI was set to 60:40.

### EXAMPLE 12

A unit cell was made in the same manner as Example 1, except that in the electrolyte preparation, LiBr and RbI were used instead of LiF and LiI, and the mole ratio of LiBr to RbI was set to 60:40.

### EXAMPLE 13

A unit cell was made in the same manner as Example 1, except that in the electrolyte preparation, LiBr and CsI were used instead of LiF and LiI, and the mole ratio of LiBr to CsI was set to 63:37.

### EXAMPLE 14

A unit cell was made in the same manner as Example 1, except that in the electrolyte preparation, NaI was used instead of LiF, and the mole ratio of NaI to LiI was set to 18:82.

### EXAMPLE 15

A unit cell was made in the same manner as Example 1, except that in the electrolyte preparation, KI was used instead of LiF, and the mole ratio of KI to LiI was set to 37:63.

### EXAMPLE 16

A unit cell was made in the same manner as Example 1, except that in the electrolyte preparation, RbI was used instead of LiF, and the mole ratio of RbI to LiI was set to 37:63.

### EXAMPLE 17

A unit cell was made in the same manner as Example 1, except that in the electrolyte preparation, CsI was used instead of LiF, and the mole ratio of CsI to LiI was set to 35:65.

### EXAMPLE 18

A unit cell was made in the same manner as Example 1, except that in the electrolyte preparation, LiBr and NaI were used instead of LiI, and the mole ratio between LiF, LiBr, and NaI was set to 5:63:32.

### EXAMPLE 19

A unit cell was made in the same manner as Example 1, except that in the electrolyte preparation, LiBr and KI were used instead of LiI, and the mole ratio between LiF, LiBr, and KI was set to 2:60:38.

### EXAMPLE 20

A unit cell was made in the same manner as Example 1, except that in the electrolyte preparation, LiBr and RbI were used instead of LiI, and the mole ratio between LiF, LiBr, and RbI was set to 2:60:38.

### EXAMPLE 21

A unit cell was made in the same manner as Example 1, except that in the electrolyte preparation, LiBr and CsI were used instead of LiI, and the mole ratio between LiF, LiBr, and CsI was set to 2:63:35.

### EXAMPLE 22

A unit cell was made in the same manner as Example 1, except that in the electrolyte preparation, LiCl, LiBr, and NaI were used instead of LiF and LiI, and the mole ratio between LiCl, LiBr, and NaI was set to 18:46:36.

### EXAMPLE 23

A unit cell was made in the same manner as Example 1, except that in the electrolyte preparation, LiCl, LiBr, and KI were used instead of LiF and LiI, and the mole ratio between LiCl, LiBr, and KI was set to 4:58:38.

### EXAMPLE 24

A unit cell was made in the same manner as Example 1, except that in the electrolyte preparation, LiCl, LiBr, and RbI were used instead of LiF and LiI, and the mole ratio between LiCl, LiBr, and RbI was set to 2:57:40.

### EXAMPLE 25

A unit cell was made in the same manner as Example 1, except that in the electrolyte preparation, LiCl, LiBr, and CsI were used instead of LiF and LiI, and the mole ratio between LiCl, LiBr, and CsI was set to 8:56:36.

### EXAMPLE 26

A unit cell was made in the same manner as Example 1, except that in the electrolyte preparation, LiCl and NaI were used instead of LiI, and the mole ratio between LiF, LiCl, and NaI was set to 5:57:38.

### EXAMPLE 27

A unit cell was made in the same manner as Example 1, except that in the electrolyte preparation, LiCl and NaI were used instead of LiI, and the mole ratio between LiF, LiCl, and NaI was set to 10:63:27.

### EXAMPLE 28

A unit cell was made in the same manner as Example 1, except that in the electrolyte preparation, LiCl and NaI were used instead of LiI, and the mole ratio between LiF, LiCl, and NaI was set to 5:50:55.

### EXAMPLE 29

A unit cell was made in the same manner as Example 1, except that in the electrolyte preparation, LiCl and NaI were used instead of LiI, and the mole ratio between LiF, LiCl, and NaI was set to 1:51:48.

### EXAMPLE 30

A unit cell was made in the same manner as Example 1, except that in the electrolyte preparation, LiCl and NaI were used instead of LiI, and the mole ratio between LiF, LiCl, and NaI was set to 1:59:40.

### EXAMPLE 31

A unit cell was made in the same manner as Example 1, except that in the electrolyte preparation, LiCl and KI were used instead of LiI, and the mole ratio between LiF, LiCl, and KI was set to 5:65:30.

### EXAMPLE 32

A unit cell was made in the same manner as Example 1, except that in the electrolyte preparation, LiCl and RbI were used instead of LiI, and the mole ratio between LiF, LiCl, and RbI was set to 5:60:35.

### EXAMPLE 33

A unit cell was made in the same manner as Example 1, except that in the electrolyte preparation, LiCl and CsI were used instead of LiI, and the mole ratio between LiF, LiCl, and CsI was set to 4:58:38.

### EXAMPLE 34

A unit cell was made in the same manner as Example 1, except that in the electrolyte preparation, LiCl, KCl, and NaI were used instead of LiF and LiI, and the mole ratio between LiCl, KCl, and NaI was set to 6:16:78.

### EXAMPLE 35

A unit cell was made in the same manner as Example 1, except that in the electrolyte preparation, LiCl, KCl, and KI were used instead of LiF and LiI, and the mole ratio between LiCl, KCl, and KI was set to 58:36:6.

### EXAMPLE 36

A unit cell was made in the same manner as Example 1, except that in the electrolyte preparation, LiCl, KCl, and RbI were used instead of LiF and LiI, and the mole ratio between LiCl, KCl, and RbI was set to 55:37:8.

### EXAMPLE 37

A unit cell was made in the same manner as Example 1, except that in the electrolyte preparation, LiCl, KCl, and CsI were used instead of LiF and LiI, and the mole ratio between LiCl, KCl, and CsI was set to 54:28:18.

### EXAMPLE 38

A unit cell was made in the same manner as Example 1, except that in the electrolyte preparation, LiCl, LiBr, and NaI were used instead of LiI, and the mole ratio between LiF, LiCl, LiBr, and NaI was set to 10:20:50:20.

### EXAMPLE 39

A unit cell was made in the same manner as Example 1, except that in the electrolyte preparation, LiCl, LiBr, and NaI were used instead of LiI, and the mole ratio between LiF, LiCl, LiBr, and NaI was set to 12:64:4:20.

### EXAMPLE 40

A unit cell was made in the same manner as Example 1, except that in the electrolyte preparation, LiCl, LiBr, and NaI were used instead of LiI, and the mole ratio between LiF, LiCl, LiBr, and NaI was set to 10:40:30:20.

### EXAMPLE 41

A unit cell was made in the same manner as Example 1, except that in the electrolyte preparation, LiCl, LiBr, and NaI were used instead of LiI, and the mole ratio between LiF, LiCl, LiBr, and NaI was set to 15:25:55:5.

### EXAMPLE 42

A unit cell was made in the same manner as Example 1, except that in the electrolyte preparation, LiCl, LiBr, and NaI were used instead of LiI, and the mole ratio between LiF, LiCl, LiBr, and NaI was set to 5:20:40:35.

### EXAMPLE 43

A unit cell was made in the same manner as Example 1, except that in the electrolyte preparation, LiCl, LiBr, and KI were used instead of LiI, and the mole ratio between LiF, LiCl, LiBr, and KI was set to 10:20:50:20.

### EXAMPLE 44

A unit cell was made in the same manner as Example 1, except that in the electrolyte preparation, LiCl, LiBr, and RbI were used instead of LiI, and the mole ratio between LiF, LiCl, LiBr, and RbI was set to 10:20:50:20.

### EXAMPLE 45

A unit cell was made in the same manner as Example 1, except that in the electrolyte preparation, LiCl, LiBr, and CsI were used instead of LiI, and the mole ratio between LiF, LiCl, LiBr, and CsI was set to 10:20:50:20.

### EXAMPLE 46

A unit cell was made in the same manner as Example 1, except that in the electrolyte preparation, LiCl, KCl, Li₂CO₃, and NaI were used instead of LiF and LiI, and the mole ratio between LiCl, KCl, Li₂CO₃, and NaI was set to 55:20:5:20.

### EXAMPLE 47

A unit cell was made in the same manner as Example 1, except that in the electrolyte preparation, LiCl, KCl, Li₂CO₃, and KI were used instead of LiF and LiI, and the mole ratio between LiCl, KCl, Li₂CO₃, and KI was set to 55:20:5:20.

### EXAMPLE 48

A unit cell was made in the same manner as Example 1, except that in the electrolyte preparation, LiCl, KCl, Li₂CO₃, and RbI were used instead of LiF and LiI, and the mole ratio between LiCl, KCl, Li₂CO₃, and RbI was set to 55:20:5:20.

### EXAMPLE 49

A unit cell was made in the same manner as Example 1, except that in the electrolyte preparation, LiCl, KCl, Li₂CO₃, and CsI were used instead of LiF and LiI, and the mole ratio between LiCl, KCl, Li₂CO₃, and CsI was set to 55:20:5:20.

### EXAMPLE 50

A unit cell was made in the same manner as Example 1, except that in the electrolyte preparation, LiCl, KCl, LiNO₃, and NaI were used instead of LiF and LiI, and the mole ratio between LiCl, KCl, LiNO₃, and NaI was set to 40:25:10:25.

### EXAMPLE 51

A unit cell was made in the same manner as Example 1, except that in the electrolyte preparation, LiCd, KCl, LiNO₃, and KI were used instead of LiF and LiI, and the mole ratio between LiCl, KCl, LiNO₃, and KI was set to 40:25:10:25.

### EXAMPLE 52

A unit cell was made in the same manner as Example 1, except that in the electrolyte preparation, LiCl, KCl, LiNO₃, and RbI were used instead of LiF and LiI, and the mole ratio between LiCl, KCl, LiNO₃, and RbI was set to 40:25:10:25.

### EXAMPLE 53

A unit cell was made in the same manner as Example 1, except that in the electrolyte preparation, LiCl, KCl, LiNO₃, and CsI were used instead of LiF and LiI, and the mole ratio between LiCl, KCl, LiNO₃, and CsI was set to 40:25:10:25.

### COMPARATIVE EXAMPLE 1

A unit cell was made in the same manner as Example 1, except that in the electrolyte preparation, LiCl and KCl were used instead of LiF and LiI, and the mole ratio of LiCl to KCl was set to 60:40.

### COMPARATIVE EXAMPLE 2

A unit cell was made in the same manner as Example 1, except that in the electrolyte preparation, LiBr, KBr, and LiCl were used instead of LiF and LiI, and the mole ratio between LiBr, KBr, and LiCl was set to 37:38:25.

### COMPARATIVE EXAMPLE 3

A unit cell was made in the same manner as Example 1, except that in the electrolyte preparation, LiBr, KBr, and LiF were used instead of LiF and LiI, and the mole ratio between LiBr, KBr, and LiF was set to 53:46:1.

### COMPARATIVE EXAMPLE 4

A unit cell was made in the same manner as Example 1, except that in the electrolyte preparation, LiBr, LiCl, and LiF were used instead of LiF and LiI, and the mole ratio between LiBr, LiCl, and LiF was set to 47:31:22.

The compositions and mixing mole ratios of the salt mixture used in the above electrolytes are shown in Tables 1 to 3. Tables 1 to 3 show the cases where the salt mixture used in the electrolyte includes two kinds, three kinds, and four kinds of salts, respectively.

TABLE 1

| | Composition | | | |
|---|---|---|---|---|
| | of Salt Mixture | | Mole Ratio of | |
| | Composition | | Salt Mixture (mol %) | |
| | 1 | Composition 2 | Composition 1 | Composition 2 |
| Comp. | LiCl | KCl | 60 | 40 |
| Ex. 1 | | | | |
| Ex. 1 | LiF | LiI | 17 | 83 |
| Ex. 2 | LiCl | LiI | 35 | 65 |
| Ex. 3 | LiCl | LiI | 25 | 75 |
| Ex. 4 | LiCl | LiI | 45 | 55 |
| Ex. 5 | LiCl | NaI | 55 | 45 |
| Ex. 6 | LiCl | KI | 63 | 37 |
| Ex. 7 | LiCl | RbI | 58 | 42 |
| Ex. 8 | LiCl | CsI | 58 | 42 |
| Ex. 9 | LiBr | LiI | 37 | 63 |
| Ex. 10 | LiBr | NaI | 60 | 40 |
| Ex. 11 | LiBr | KI | 60 | 40 |
| Ex. 12 | LiBr | RbI | 60 | 40 |
| Ex. 13 | LiBr | CsI | 63 | 37 |
| Ex. 14 | NaI | LiI | 18 | 82 |
| Ex. 15 | KI | LiI | 37 | 63 |
| Ex. 16 | RbI | LiI | 37 | 63 |
| Ex. 17 | CsI | LiI | 35 | 65 |

TABLE 2

| | Composition of Salt | | | Mole Ratio of Salt Mixture | | |
|---|---|---|---|---|---|---|
| | Mixture | | | (mol %) | | |
| | Composition 1 | Composition 2 | Composition 3 | Composition 1 | Composition 2 | Composition 3 |
| Comp. Ex. 2 | LiBr | KBr | LiCl | 37 | 38 | 25 |
| Comp. Ex. 3 | LiBr | KBr | LiF | 53 | 46 | 1 |
| Comp. Ex. 4 | LiBr | LiCl | LiF | 47 | 31 | 22 |
| Example 18 | LiF | LiBr | NaI | 5 | 63 | 32 |
| Example 19 | LiF | LiBr | KI | 2 | 60 | 38 |
| Example 20 | LiF | LiBr | RbI | 2 | 60 | 38 |
| Example 21 | LiF | LiBr | CsI | 2 | 63 | 35 |
| Example 22 | LiCl | LiBr | NaI | 18 | 46 | 36 |
| Example 23 | LiCl | LiBr | KI | 4 | 58 | 38 |
| Example 24 | LiCl | LiBr | RbI | 2 | 57 | 40 |
| Example 25 | LiCl | LiBr | CsI | 8 | 56 | 36 |
| Example 26 | LiF | LiCl | NaI | 5 | 57 | 38 |
| Example 27 | LiF | LiCl | NaI | 10 | 63 | 27 |
| Example 28 | LiF | LiCl | NaI | 5 | 50 | 55 |
| Example 29 | LiF | LiCl | NaI | 1 | 51 | 48 |
| Example 30 | LiF | LiCl | NaI | 1 | 59 | 40 |
| Example 31 | LiF | LiCl | KI | 6 | 64 | 30 |
| Example 32 | LiF | LiCl | RbI | 5 | 60 | 35 |
| Example 33 | LiF | LiCl | CsI | 4 | 58 | 38 |
| Example 34 | LiCl | KCl | NaI | 6 | 16 | 78 |
| Example 35 | LiCl | KCl | KI | 58 | 36 | 6 |
| Example 36 | LiCl | KCl | RbI | 55 | 37 | 8 |
| Example 37 | LiCl | KCl | CsI | 54 | 27 | 19 |

TABLE 3

| | | | | | Mole Ratio of Salt Mixture | | | |
|---|---|---|---|---|---|---|---|---|
| | Composition of Salt Mixture | | | | (mol %) | | | |
| | composition | Composition | Composition | Composition | Composition | Composition | Composition | Compostion |
| | 1 | 2 | 3 | 4 | 1 | 2 | 3 | 4 |
| Ex. 38 | LiF | LiCl | LiBr | NaI | 10 | 20 | 50 | 20 |
| Ex. 39 | LiF | LiCl | LiBr | NaI | 12 | 64 | 4 | 20 |
| Ex. 40 | LiF | LiCl | LiBr | NaI | 10 | 40 | 30 | 20 |
| Ex. 41 | LiF | LiCl | LiBr | NaI | 15 | 25 | 55 | 5 |
| Ex. 42 | LiF | LiCl | LiBr | NaI | 5 | 20 | 40 | 35 |
| Ex. 43 | LiF | LiCl | LiBr | KI | 10 | 20 | 50 | 20 |
| Ex. 44 | LiF | LiCl | LiBr | RbI | 10 | 20 | 50 | 20 |
| Ex. 45 | LiF | LiCl | LiBr | CsI | 10 | 20 | 50 | 20 |
| Ex. 46 | LiCl | KCl | Li₂CO₃ | NaI | 55 | 20 | 5 | 20 |
| Ex. 47 | LiCl | KCl | Li₂CO₃ | KI | 55 | 20 | 5 | 20 |
| Ex. 48 | LiCl | KCl | Li₂CO₃ | RbI | 55 | 20 | 5 | 20 |
| Ex. 49 | LiCl | KCl | Li₂CO₃ | CsI | 55 | 20 | 5 | 20 |
| Ex. 50 | LiCl | KCl | LiNO₃ | NaI | 40 | 25 | 10 | 25 |
| Ex. 51 | LiCl | KCl | LiNO₃ | KI | 40 | 25 | 10 | 25 |
| Ex. 52 | LiCl | KCl | LiNO₃ | RbI | 40 | 25 | 10 | 25 |
| Ex. 53 | LiCl | KCl | LiNO₃ | CsI | 40 | 25 | 10 | 25 |

Evaluations as in below were conducted for each unit cell prepared in the above.

[Evaluation]

(A) Discharge Test

The unit cell was sandwiched between two temperature-controllable thermal plates, and the unit cell was heated by the thermal plates to operating temperatures. A discharge was carried out at a constant current (End Voltage:1.2 V), to determine discharge capacity. At this time, the discharge voltage after ten seconds from the start of the discharge was also checked. To evaluate high-rate discharge performance, discharge current rate was set to 2.0 A/cm². Also, the temperature of the thermal plates was set so that temperature at the time of discharge was set to 450° C., 500° C., or 550° C., to carry out the discharge test with the respective temperatures. The discharge capacity was obtained as a capacity ratio relative to the discharge capacity where the battery was discharged at 500° C., i.e., a general operating temperature in the case where LiCl—KCl was used for the electrolyte, and a current of 0.5 A/cm² until reaching 1.2V. The number of the batteries tested was five, and an average value of the capacity ratios for the five batteries was obtained.

(B) Short Circuit Test

Additionally, as one of the important requirements for electrolytes used in thermal batteries, for example, upon discharging under high temperatures, a short circuit between the positive electrode and the negative electrode due to a leakage of electrolyte needs to be hindered. In view of this, occurrence/non-occurrence of a short circuit was checked based on the decreasing behavior of the discharge voltage during the discharge test, and presence/absence of the electrolyte leakage after the discharge test. Five batteries were made for each kind of electrolyte, and the rate for short circuit occurrence was checked.

The evaluation results of the above are shown in Tables 4 to 6. Tables 4 to 6 show the evaluation results for the case where the salt mixture to be used for the electrolyte includes two kinds, three kinds, and four kinds of salts.

TABLE 4

| | | | | Occurrence Rate | | |
|---|---|---|---|---|---|---|
| | Capacity Ratio | | | of Short Circuit by | | |
| | (%) | | | Electrolyte Leakage (%) | | |
| | 450° C. | 500° C. | 550° C. | 450° C. | 500° C. | 550° C. |
| Comp. Ex. 1 | 77 | 85 | 94 | 0 | 0 | 0 |
| Example 1 | 87 | 94 | 96 | 0 | 0 | 0 |
| Example 2 | 89 | 95 | 97 | 0 | 0 | 0 |
| Example 3 | 88 | 94 | 96 | 0 | 0 | 0 |
| Example 4 | 86 | 94 | 96 | 0 | 0 | 0 |
| Example 5 | 86 | 93 | 96 | 0 | 0 | 0 |
| Example 6 | 85 | 92 | 96 | 0 | 0 | 0 |
| Example 7 | 86 | 91 | 94 | 0 | 0 | 0 |
| Example 8 | 85 | 92 | 94 | 0 | 0 | 0 |
| Example 9 | 87 | 92 | 96 | 0 | 0 | 0 |
| Example 10 | 85 | 90 | 94 | 0 | 0 | 0 |
| Example 11 | 86 | 91 | 94 | 0 | 0 | 0 |
| Example 12 | 85 | 90 | 92 | 0 | 0 | 0 |
| Example 13 | 86 | 91 | 94 | 0 | 0 | 0 |
| Example 14 | 86 | 90 | 93 | 0 | 0 | 0 |
| Example 15 | 85 | 89 | 91 | 0 | 0 | 0 |
| Example 16 | 85 | 88 | 90 | 0 | 0 | 0 |
| Example 17 | 85 | 88 | 91 | 0 | 0 | 0 |

TABLE 5

| | | | | Occurrence Rate of | | |
|---|---|---|---|---|---|---|
| | Capacity Ratio | | | Short Circuit by | | |
| | (%) | | | Electrolyte Leakage (%) | | |
| | 450° C. | 500° C. | 550° C. | 450° C. | 500° C. | 550° C. |
| Comp. Ex. 2 | 75 | 83 | 93 | 1 | 0 | 0 |
| Comp. Ex. 3 | 73 | 81 | 92 | 2 | 1 | 1 |
| Comp. Ex. 4 | 12 | 96 | 99 | 0 | 1 | 0 |
| Example 18 | 90 | 95 | 98 | 0 | 0 | 0 |
| Example 19 | 89 | 93 | 96 | 0 | 0 | 0 |
| Example 20 | 89 | 92 | 95 | 0 | 0 | 0 |
| Example 21 | 88 | 95 | 97 | 0 | 0 | 0 |
| Example 22 | 89 | 95 | 98 | 0 | 0 | 0 |
| Example 23 | 88 | 93 | 96 | 0 | 0 | 0 |
| Example 24 | 89 | 94 | 97 | 0 | 0 | 0 |
| Example 25 | 89 | 95 | 98 | 0 | 0 | 0 |
| Example 26 | 95 | 97 | 99 | 0 | 0 | 0 |
| Example 27 | 96 | 99 | 100 | 0 | 0 | 0 |
| Example 28 | 95 | 97 | 99 | 0 | 0 | 0 |
| Example 29 | 93 | 96 | 98 | 0 | 0 | 0 |
| Example 30 | 94 | 97 | 99 | 0 | 0 | 0 |
| Example 31 | 95 | 97 | 99 | 0 | 0 | 0 |
| Example 32 | 94 | 96 | 98 | 0 | 0 | 0 |
| Example 33 | 92 | 95 | 98 | 0 | 0 | 0 |
| Example 34 | 90 | 96 | 98 | 0 | 0 | 0 |
| Example 35 | 91 | 95 | 98 | 0 | 0 | 0 |
| Example 36 | 89 | 94 | 97 | 0 | 0 | 0 |
| Example 37 | 89 | 94 | 97 | 0 | 0 | 0 |

TABLE 6

| | | | | Occurrence Rate of | | |
|---|---|---|---|---|---|---|
| | Capacity Ratio | | | Short Circuit by | | |
| | (%) | | | Electrolyte Leakage (%) | | |
| | 450° C. | 500° C. | 550° C. | 450° C. | 500° C. | 550° C. |
| Example 38 | 93 | 98 | 101 | 0 | 0 | 0 |
| Example 39 | 97 | 100 | 102 | 0 | 0 | 0 |
| Example 40 | 96 | 99 | 101 | 0 | 0 | 0 |
| Example 41 | 93 | 99 | 100 | 0 | 0 | 0 |
| Example 42 | 92 | 97 | 98 | 0 | 0 | 0 |
| Example 43 | 94 | 98 | 101 | 0 | 0 | 0 |
| Example 44 | 93 | 97 | 101 | 0 | 0 | 0 |
| Example 45 | 92 | 96 | 100 | 0 | 0 | 0 |
| Example 46 | 90 | 94 | 97 | 0 | 0 | 0 |
| Example 47 | 89 | 93 | 97 | 0 | 0 | 0 |
| Example 48 | 88 | 92 | 96 | 0 | 0 | 0 |
| Example 49 | 87 | 92 | 97 | 0 | 0 | 0 |
| Example 50 | 92 | 95 | 98 | 0 | 0 | 0 |
| Example 51 | 90 | 94 | 98 | 0 | 0 | 0 |
| Example 52 | 90 | 93 | 97 | 0 | 0 | 0 |
| Example 53 | 88 | 92 | 97 | 0 | 0 | 0 |

In batteries of Examples 1 to 53, high capacity rates of over 85% were obtained under any temperatures, compared with batteries of Comparative Examples 1 to 4. This is due to, for example, a low electronegativity value (criterion for ability to attract electrons) of iodine compared with fluorine, chlorine, and bromine, declining stability of iodide more than other halogen compounds. Thus, the melting point of a salt mixture with iodide added declines. Therefore, the electrolyte can maintain its molten state even under the temperature range lower than conventional temperature (for example, 450° C.), and excellent ion conductivity can be exhibited.

Additionally, in Examples 1 to 53, no electrolyte leakage that causes a short circuit in thermal batteries can be found in any batteries. This is probably because the usage of iodide as a salt of the electrolyte made melting of the electrolyte easier, rendering MgO to be easily blended with, improving the homogeneity in the mixture of salts such as iodide and MgO, and improving homogeneity of reaction and homogeneity of physical strength.

Although, in Examples 1 to 53, the same salt as the salt used for electrolyte were added to both the positive electrode and the negative electrode, because the ion conductivity of the electrolyte is one of the important factor to determine the discharge characteristic, the present invention is not limited to these examples. A salt different from the salt used for the electrolyte may be added to at least one of the positive electrode and the negative electrode, even when the melting point of the salt added to the electrode is eqal or close to the melting point of the salt used for the electrolyte.

### EXAMPLE 54

By using the unit cells in Example 1, the thermal batteries same as the one in FIG. 1 as mentioned above were made. The thermal batteries were fabricated under a dry air environment with a dew point of −50° C. or below, where effects from moisture were eliminated to the maximum.

The unit cells 7 and the heating agents 5 were stacked alternately to form a power-generating portion. Thirteen unit cells 7 were used. For the heating agent 5, a mixture of Fe and KClO₄ was used. The mixture amount was adjusted so that the average temperature during the battery operation becomes 450, 500, or 550° C.

In this Example, although the temperature during battery operation was adjusted by changing the heating agent amount, the proportion of each material in the heating agent may be changed for the adjustment.

When the temperature at the time of the thermal battery operation is set to 450° C., since operating temperature is low compared with the case where the thermal battery operation temperature is set to 500° C. and 550° C., small and lightweight thermal batteries can be achieved by decreasing the heating agent amount.

On top of the power-generating portion, an ignition pad 4 was disposed, and along the circumference of the power-generating portion, a fuse wrap 6 was disposed. For the ignition pad 4 and the fuse wrap 6, a mixture of Zr, BaCrO₄, and glass fiber was used.

For an ignition material for an igniter 3, a mixture of potassium nitrate, sulfur, and carbon was used. For thermal insulating materials 9a and 9b, a ceramic fiber material mainly composed of silica and alumina was used.

### EXAMPLE 55

A thermal battery was made in the same manner as Example 54, except that the unit cell of Example 2 was used instead of the unit cell of Example 1.

### EXAMPLE 56

A thermal battery was made in the same manner as Example 54, except that the unit cell of Example 9 was used instead of the unit cell of Example 1.

### EXAMPLE 57

A thermal battery was made in the same manner as Example 54, except that the unit cell of Example 14 was used instead of the unit cell of Example 1.

### EXAMPLE 58

A thermal battery was made in the same manner as Example 54, except that the unit cell of Example 18 was used instead of the unit cell of Example 1.

### EXAMPLE 59

A thermal battery was made in the same manner as Example 54, except that the unit cell of Example 22 was used instead of the unit cell of Example 1.

### EXAMPLE 60

A thermal battery was made in the same manner as Example 54, except that the unit cell of Example 26 was used instead of the unit cell of Example 1.

### EXAMPLE 61

A thermal battery was made in the same manner as Example 54, except that the unit cell of Example 34 was used instead of the unit cell of Example 1.

### EXAMPLE 62

A thermal battery was made in the same manner as Example 54, except that the unit cell of Example 38 was used instead of the unit cell of Example 1.

### EXAMPLE 63

A thermal battery was made in the same manner as Example 54, except that the unit cell of Example 46 was used instead of the unit cell of Example 1.

### EXAMPLE 64

A thermal battery was made in the same manner as Example 54, except that the unit cell of Example 50 was used instead of the unit cell of Example 1.

The discharge test was carried out for thermal batteries in Examples 54 to 64, as in the following. A high voltage was applied from a power source connected to an ignition terminal to fire the igniter, thereby activating the thermal battery. Then, the thermal battery was discharged at a current density of 2 A/cm² (end voltage: 6.5 V). As a result, it was confirmed that in the thermal battery in which a plurality of unit cells were stacked, the same capacity with the unit cell can be obtained.

In thermal batteries, high voltages are required in addition to high electric currents in many cases. Thus, general thermal batteries, as the one shown in FIG. 2, comprises a power-generating portion in which a plurality of unit cells and heating agents are stacked alternately. Performance of thermal batteries heavily depends on unit cell performance, as described above. That is, regardless of the number of the unit cell to be stacked, improvement in unit cell performance enables obtaining high performance thermal batteries.

Although the electrolyte in the above Examples had a disk form with a diameter of 13 mm, the size and shape are not particularly limited, and may be for example a donut form with a hole in the center, semicircular, and rectangular.

The thermal battery of the present invention is excellent in output performance, and is suitably used for power sources for various ordinance devices such as missile and guidance system, and for emergency power sources.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A thermal battery including a unit cell comprising:
a positive electrode;
a negative electrode; and
an electrolyte disposed between said positive electrode and said negative electrode, said electrolyte comprising a salt molten at an operating temperature of said thermal battery, said salt comprising an inorganic cation and an inorganic anion,
wherein said inorganic anion includes at least an iodine anion.

2. The thermal battery in accordance with claim 1, wherein said inorganic cation is at least one selected from the group consisting of a lithium cation, a sodium cation, a potassium cation, a rubidium cation, and a cesium cation.

3. The thermal battery in accordance with claim 1, wherein said inorganic anion is said iodine anion, and at least one selected from the group consisting of a fluorine anion, a chlorine anion, a bromine anion, a nitric acid anion, and a carbonic acid anion.

4. The thermal battery in accordance with claim 1, wherein said salt comprises at least a first salt including said iodine anion, and a second salt including at least one inorganic anion selected from the group consisting of said iodine anion, a fluorine anion, a chlorine anion, a bromine anion, a nitric acid anion, and a carbonic acid anion.

5. The thermal battery in accordance with claim 4, wherein said first salt is at least one selected from the group consisting of LiI, NaI, KI, RbI, and CsI.

6. The thermal battery in accordance with claim 1, wherein at least one of said negative electrode and said positive electrode includes a salt including an iodine anion.
